(19) United States
(12) Patent Application Publication
(10) Pub. No.: US 2016/0188073 A1
(43) Pub. Date: Jun. 30, 2016

(54) TOUCH DISPLAY PANEL AND TOUCH DISPLAY DEVICE

(71) Applicant: SHENZHEN CHINA STAR OPTOELECTRONICS TECHNOLOGY CO., LTD., Shenzhen (CN)

(72) Inventor: Wei Ren, Shenzhen (CN)

(21) Appl. No.: 14/417,797

(22) PCT Filed: Dec. 29, 2014
(86) PCT No.: PCT/CN2014/095293

§ 371 Date: Jan. 28, 2015

(30) Foreign Application Priority Data
Dec. 24, 2014 (CN) 201410814994.0

(51) Int. Cl. G06F 3/041; G06F 3/044

(52) U.S. Cl. CPC G06F 3/0416; G06F 3/0412; G06F 3/044; G06F 2203/04103

(57) ABSTRACT

A touch display panel and a touch display device are provided. The panel has a plurality of stripe-like driving elements for receiving driving signals, a plurality of stripe-like detecting elements alternately arranged with the stripe-like driving elements for generating detecting signals according to the driving signals and the touch signals, a cross section of the stripe-like detecting element and the stripe-like detecting elements are a layered structure with a first transparent conductive layer, a metal layer, and a second transparent conductive layer.

### FIELD OF THE INVENTION

The present invention relates to a technical field of an LCD display, and in particular to a touch display panel and a touch display device.

### BACKGROUND OF THE INVENTION

As smart phones and tablet computers are widely used, the technology of the touch panel display has advanced. The traditional touch panel is mainly applied in a device with a small size screen due to traditional touch panels having large impedance; traditional touch panels cannot be applied in large-sized machines or notebooks.

The traditional touch panel has a plurality of driving elements, and a plurality of detecting elements arranged with the driving elements. One manufacturing method is that the driving elements and the detecting elements are made by a signal layer of indium tin oxide. However, the impedance is increased by the indium tin oxide, and thus the power consumption is large. Another manufacturing method is that the driving elements and the detecting elements are made by a signal layer of metal, but the metal blocks light, and thus the aperture ratio of the panel is reduced.

Therefore, a touch display panel and a touch display device are desired to be developed which solve the problems existing in the conventional as described above.

### SUMMARY OF THE INVENTION

A primary object of the present invention is to provide a touch display panel and a touch display device which solve the problems of large impedance and low aperture ratio in the conventional art.

To achieve the above object, the present invention provides a touch display panel which comprises a plurality of stripe-like driving elements for receiving driving signals, a plurality of stripe-like detecting elements alternately arranged with the stripe-like driving elements for generating detecting signals according to the driving signals and the touch signals of the stripe-like driving elements, a driving unit for providing the driving signals to the stripe-like driving elements, and a detecting unit for detecting whether the touch signals are formed on the touch display panel and generating a detected result. A cross section of the stripe-like driving element is a layered structure with a first transparent conductive layer, a metal layer, and a second transparent conductive layer. A cross section of the stripe-like detecting element is a layered structure with a first transparent conductive layer, a metal layer, and a second transparent conductive layer. A material of the metal layer is silver, and a material of the first transparent conductive layer and the second transparent conductive layer is indium tin oxide.

In one embodiment of the present invention, a thickness of the silver is greater than 0 nanometers and less than 20 nanometers.

In one embodiment of the present invention, a thickness of the silver is greater than 8 nanometers and less than 15 nanometers.

In one embodiment of the present invention, the detecting unit processes the detecting signals to get generating positions of the touch signals when the detected result is that the touch signals are in the touch display panel.

To achieve the above object, the present invention provides a touch display panel which comprises a plurality of stripe-like driving elements for receiving driving signals, and a plurality of stripe-like detecting elements staggered with the stripe-like driving elements for generating detecting signals according to the driving signals and the touch signals of the stripe-like driving elements. A cross section of the stripe-like driving element is a layered structure with a first transparent conductive layer, a metal layer, and a second transparent conductive layer. A cross section of the stripe-like detecting element is a layered structure with a first transparent conductive layer, a metal layer, and a second transparent conductive layer.

In one embodiment of the present invention, a material of the metal layer is silver, and a material of the first transparent conductive layer and the second transparent conductive layer is indium tin oxide.

In one embodiment of the present invention, a thickness of the silver is greater than 0 nanometers and less than 20 nanometers.

In one embodiment of the present invention, a thickness of the silver is greater than 8 nanometers and less than 15 nanometers.

In one embodiment of the present invention, the touch display panel further comprises a driving unit for providing the driving signals to the stripe-like driving elements, and a detecting unit for detecting whether the touch signals are formed on the touch display panel and generating a detected result.

In one embodiment of the present invention, the detecting unit processes the detecting signals to get generating positions of the touch signals when the detected result is that the touch signals are in the touch display panel.

To achieve the above object, the present invention provides a touch display device which comprises a backlight and a touch display panel. The touch display panel comprises a plurality of stripe-like driving elements for receiving driving signals, and a plurality of stripe-like detecting elements staggered with the stripe-like driving elements for generating detecting signals according to the driving signals and the touch signals of the stripe-like driving elements. A cross section of the stripe-like driving element is a layered structure with a first transparent conductive layer, a metal layer, and a second transparent conductive layer. A cross section of the stripe-like detecting element is a layered structure with a first transparent conductive layer, a metal layer, and a second transparent conductive layer.

In one embodiment of the present invention, a material of the metal layer is silver, a material of the first transparent conductive layer and the second transparent conductive layer is indium tin oxide.

In one embodiment of the present invention, a thickness of the silver is greater than 0 nanometers and less than 20 nanometers.

In one embodiment of the present invention, a thickness of the silver is greater than 8 nanometers and less than 15 nanometers.

In one embodiment of the present invention, the touch display panel further comprises a driving unit for providing the driving signals to the stripe-like driving elements, and a detecting unit for detecting whether the touch signals are formed on the touch display panel and generating a detected result.

In one embodiment of the present invention, the detecting unit processes the detecting signals to get generating positions of the touch signals when the detected result is that the touch signals are formed on the touch display panel.

The present invention provides a touch display panel and a touch display device, which develop the driving elements and the detecting elements. Thus the impedance can be reduced, and the aperture ratio of the panel can be improved.

### DESCRIPTION OF THE DRAWINGS

FIG. 1 is a schematic view of a touch display panel according to the first embodiment of the present invention.

FIG. 2 is a cross-sectional view of a stripe-like driving element or a stripe-like detecting element of the touch display panel.

FIG. 3 is a schematic view of a touch display panel according to the second embodiment of the present invention.

### DETAILED DESCRIPTION OF THE PREFERRED EMBODIMENTS

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, etc., are only directions by referring to the accompanying drawings, and thus the used directional terms are used to describe and understand the present invention, but the present invention is not limited thereto.

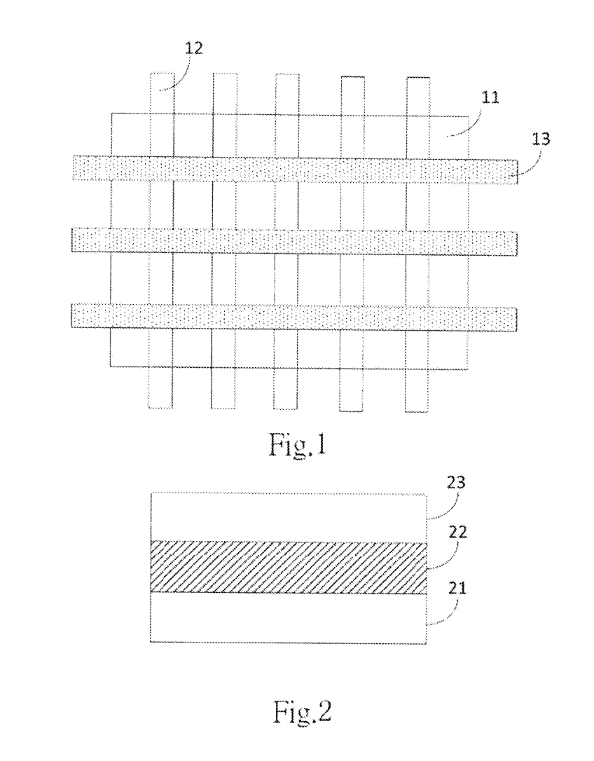

Refer to FIG. 1, which is a schematic view of a touch display panel according to the first embodiment of the present invention.

A touch display panel of the present invention in FIG. 1 comprises a substrate 11, a plurality of stripe-like driving elements 12, and a plurality of stripe-like detecting elements 13. The stripe-like detecting elements 13 are staggered with the stripe-like driving elements 12 (not connected). For example, the stripe-like detecting elements 13 are disposed along a direction X (not shown), and the stripe-like driving elements 12 are disposed along a direction Y (not shown). The stripe-like detecting elements 13 and the stripe-like driving elements 12 are vertically staggered. A detecting array is formed on the substrate 11 by staging the stripe-like detecting elements 13 and the stripe-like driving elements 12. The substrate 11 is a transparent substrate, such as a glass substrate or a polyethylene terephthalate (PET) substrate.

The stripe-like driving elements 12 receives driving signals by inputting from a display area. According to the driving signals and the touch signals, detecting signals are generated and formed by using the stripe-like detecting elements 13. The touch signals are generated when the detecting array is touched.

The stripe-like detecting elements 13 and the stripe-like driving elements 12 are staggered. Thus, a capacitance is formed between the stripe-like detecting elements 13 and the stripe-like driving elements 12 when the driving signals are inputted from the stripe-like driving elements 12. The capacitance value of a touch area is changed and the detecting signals are outputted when the user touches the touch display panel. The detecting signals of the touched area and the detecting signals of the untouched area are different.

Refer to FIG. 2. A cross section of the stripe-like driving element 12 is a layered structure with a first transparent conductive layer 21, a metal layer 22, and a second transparent conductive layer 23. A cross section of the stripe-like detecting element 13 is also a layered structure with a first transparent conductive layer 21, a metal layer 22, and a second transparent conductive layer 23.

The present invention provides a touch display panel, which develops the improved material for the driving elements and the detecting elements. The single layer of the metal layer or the transparent conductive layer is changed to a layered structure with a metal layer between two transparent conductive layers. The impedance of the metal layer is less than the impedance of transparent conductive layer, thus the impedance can be reduced.

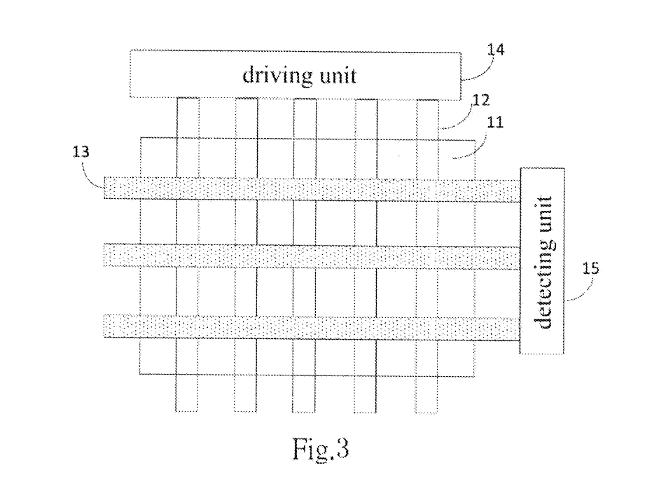

Refer to FIG. 3, which is a schematic view of a touch display panel according to the second embodiment of the present invention.

As shown, the difference of the second embodiment is that a material of the metal layer is preferably a transparent metal with a small impedance. The material of the metal layer is silver, and a material of the first transparent conductive layer and the second transparent conductive layer is indium tin oxide. The material of the first transparent conductive layer and the second transparent conductive layer is also indium zinc oxide. The impedance of the silver is small, and thus the impedance of the touch display panel is also small.

Preferably, a thickness of the silver is greater than 0 nanometers and less than 20nanometers. The transmittance of the touch display panel is not enough if the silver is too thick, and the impedance of indium tin oxide is large and cannot be reduced if the silver is too thin. The thickness of the silver is greater than 8 nanometers and less than 15 nanometers. The impedance can be reduced and the transmittance is better.

Preferably, the stripe-like detecting elements and the stripe-like driving elements are staggered and isolated, and formed to a grid on the touch display panel. The touch area is more sensitive due to the grid of the stripe-like detecting elements and the stripe-like driving elements.

Preferably, referring to FIG. 3, the touch display panel further comprises a driving unit 14 and a detecting unit 15.

The driving unit 14 is connected to the stripe-like driving elements 12 for providing the driving signals to the stripe-like driving elements 12. The detecting unit 15 is connected to the stripe-like detecting elements 13. The detecting elements 13 generate detecting signals and output the detecting signals to the detecting unit 15. The detecting unit 15 detects whether the touch signals are formed on the touch display panel according the detecting signals (whether the detecting array is touched), and generates a position of the touch signals by processing the detecting signals.

The touch display panel further comprises a plurality of detecting units coupled to a related stripe-like driving element and a related stripe-like detecting element, respectively. The stripe-like detecting element outputs the detecting signals by transmitting the driving signals to each detecting units via the related stripe-like driving element and reading the detecting signals of each detecting unit via the related stripe-like detecting element. The touch area is also detected, and the steps of the manufacturing method for the stripe-like driving elements and the stripe-like detecting elements can be decreased.

The present invention provides a touch display panel which develops the improved material for the driving elements and the detecting elements. The single layer of the metal layer or the transparent conductive layer is changed to a layered structure with a metal layer between two transparent conductive layers, and the thickness of the silver is limited in range. The impedance of the metal layer is less than the impedance of transparent conductive layer, and thus the impedance can be reduced.

The present invention further provides a touch display device which comprises a backlight and a touch display panel. The backlight is preferably a directional backlight to avoid consumption of a light source.

The touch display panel comprises a substrate, a plurality of stripe-like driving elements, and a plurality of stripe-like detecting elements. The stripe-like detecting elements are staggered with the stripe-like driving elements. For example, the stripe-like detecting elements are disposed along a direction X, and the stripe-like driving elements are disposed along a direction Y. The stripe-like detecting elements and the stripe-like driving elements are vertically staggered. A detecting array is formed on the substrate by staging the stripe-like detecting elements and the stripe-like driving elements. The substrate is a transparent substrate, such as a glass substrate or a polyethylene terephthalate (PET) substrate.

The stripe-like driving elements receive driving signals by inputting from a display area. The stripe-like detecting elements generates detecting signals according to the driving signals and the touch signals. The touch signals are generated when the detecting array is touched.

The stripe-like detecting elements and the stripe-like driving elements are staggered. Thus, a capacitance is formed between the stripe-like detecting elements and the stripe-like driving elements when the driving signals are inputted from the stripe-like driving elements. The capacitance value of a touch area is changed and the detecting signals are outputted when the user touches the touch display panel. The detecting signals of the touched area and the detecting signals of the untouched area are different.

A cross section of the stripe-like driving element is a layered structure with a first transparent conductive layer, a metal layer, and a second transparent conductive layer. A cross section of the stripe-like detecting element is also a layered structure with a first transparent conductive layer, a metal layer, and a second transparent conductive layer.

The touch display device of present invention can be provide in another embodiment as below:

The material of the metal layer is preferably a transparent metal with a small impedance. The material of the metal layer is silver, and a material of the first transparent conductive layer and the second transparent conductive layer is indium tin oxide. The material of the first transparent conductive layer and the second transparent conductive layer is also indium zinc oxide. The impedance of the silver is small, and thus the impedance of the touch display panel is also small.

Preferably, a thickness of the silver is greater than 0 nanometers and less than 20 nanometers. The transmittance of the touch display panel is not enough if the silver is too think, and the impedance of indium tin oxide is large and cannot be reduced if the silver is too thin. The thickness of the silver is greater than 8 nanometers and less than 15 nanometers. The impedance can be reduced and the transmittance is better.

Preferably, the stripe-like detecting elements and the stripe-like driving elements are staggered and isolated, and formed to a grid on the touch display panel. The touch area is more sensitive due to the grid of the stripe-like detecting elements and the stripe-like driving elements.

The touch display panel further comprises a driving unit and a detecting unit.

The driving unit is connected to the stripe-like driving elements for providing the driving signals to the stripe-like driving elements. The detecting unit is connected to the stripe-like detecting elements. The detecting elements generate detecting signals and output the detecting signals to the detecting unit. The detecting unit detects whether the touch signals are formed on the touch display panel according the detecting signals (whether the detecting array is touched), and generates a position of the touch signals by processing the detecting signals.

The touch display panel further comprises a plurality of detecting units coupled to a related stripe-like driving element and a related stripe-like detecting element respectively. The stripe-like detecting element outputs the detecting signals by transmitting the driving signals to each detecting units via the related stripe-like driving element and reading the detecting signals of each detecting unit via the related stripe-like detecting element. The touch area is also detected, and the steps of the manufacturing method for the stripe-like driving elements and the stripe-like detecting elements can be decreased.

The touch display device is improved by developing the material of the driving elements and the detecting elements. The single layer of the metal layer or the transparent conductive layer is changed to a layered structure with a metal layer between two transparent conductive layers, and the thickness of the silver is limited in range. The impedance of the metal layer is less than the impedance of transparent conductive layer, and thus the impedance can be reduced.

The present invention has been described with preferred embodiments thereof, and it is understood that many changes and modifications to the described embodiments can be carried out without departing from the scope and the spirit of the invention that is intended to be limited only by the appended claims.

What is claimed is:

1. A touch display panel comprising:
a plurality of stripe-like driving elements for receiving driving signals;
a plurality of stripe-like detecting elements alternately arranged with the stripe-like driving elements for generating detecting signals according to the driving signals and the touch signals of the stripe-like driving elements;
a driving unit for providing the driving signals to the stripe-like driving elements; and
a detecting unit for detecting whether the touch signals are formed on the touch display panel and generating a detected result;
wherein a cross section of the stripe-like driving element is a layered structure with a first transparent conductive layer, a metal layer, and a second transparent conductive layer;
wherein a cross section of the stripe-like detecting element is a layered structure with a first transparent conductive layer, a metal layer, and a second transparent conductive layer;
wherein a material of the metal layer is silver, and a material of the first transparent conductive layer and the second transparent conductive layer is indium tin oxide.

2. The touch display panel according to claim 1, wherein a thickness of the silver is greater than 0 nanometers and less than 20 nanometers.

3. The touch display panel according to claim 2, wherein a thickness of the silver is greater than 8 nanometers and less than 15 nanometers.

4. The touch display panel according to claim 1, wherein the detecting unit processes the detecting signals to get generating positions of the touch signals when the detected result is that the touch signals are in the touch display panel.

5. A touch display panel comprising:
a plurality of stripe-like driving elements for receiving driving signals; and
a plurality of stripe-like detecting elements staggered with the stripe-like driving elements for generating detecting signals according to the driving signals and the touch signals of the stripe-like driving elements;
wherein a cross section of the stripe-like driving element is a layered structure with a first transparent conductive layer, a metal layer, and a second transparent conductive layer;
wherein a cross section of the stripe-like detecting element is a layered structure with a first transparent conductive layer, a metal layer, and a second transparent conductive layer.

6. The touch display panel according to claim 5, wherein a material of the metal layer is silver, and a material of the first transparent conductive layer and the second transparent conductive layer is indium tin oxide.

7. The touch display panel according to claim 6, wherein a thickness of the silver is greater than 0 nanometers and less than 20 nanometers.

8. The touch display panel according to claim 7, wherein a thickness of the silver is greater than 8 nanometers and less than 15 nanometers.

9. The touch display panel according to claim 5, wherein the touch display panel further comprises:
a driving unit for providing the driving signals to the stripe-like driving elements; and
a detecting unit for detecting whether the touch signals are formed on the touch display panel and generating a detected result.

10. The touch display panel according to claim 9, wherein the detecting unit processes the detecting signals to get generating positions of the touch signals when the detected result is that the touch signals are on the touch display panel.

11. A touch display device comprising:
a backlight, and a touch display panel;
wherein the touch display panel comprises:
a plurality of stripe-like driving elements for receiving driving signals;
a plurality of stripe-like detecting elements staggered with the stripe-like driving elements for generating detecting signals according to the driving signals and the touch signals of the stripe-like driving elements;
wherein a cross section of the stripe-like driving element is a layered structure with a first transparent conductive layer, a metal layer, and a second transparent conductive layer;
wherein a cross section of the stripe-like detecting element is a layered structure with a first transparent conductive layer, a metal layer, and a second transparent conductive layer.

12. The touch display device according to claim 11, wherein a material of the metal layer is silver, a material of the first transparent conductive layer and the second transparent conductive layer is indium tin oxide.

13. The touch display device according to claim 12, wherein a thickness of the silver is greater than 0 nanometers and less than 20 nanometers.

14. The touch display device according to claim 13, wherein a thickness of the silver is greater than 8 nanometers and less than 15 nanometers.

15. The touch display device according to claim 11, wherein the touch display panel further comprises:
a driving unit for providing the driving signals to the stripe-like driving elements; and
a detecting unit for detecting whether the touch signals are formed on the touch display panel and generating a detected result.

16. The touch display device according to claim 15, wherein the detecting unit processes the detecting signals to get generating positions of the touch signals when the detected result is that the touch signals are formed on the touch display panel.
